(19) United States
(12) Patent Application Publication
(10) Pub. No.: US 2008/0289885 A1
(43) Pub. Date: Nov. 27, 2008

(54) Force-Based Input Device Having a Dynamic User Interface

(76) Inventors: James K. Elwell, Salt Lake City, UT (US); David A. Soss, Salt Lake City, UT (US)

Correspondence Address: THORPE NORTH & WESTERN, LLP., P.O. Box 1219, SANDY, UT, 84091-1219, US

(21) Appl. No.: 12/125,906

(22) Filed: May 22, 2008

Related U.S. Application Data
(60) Provisional application No. 60/931,400, filed on May 22, 2007.

(51) Int. Cl. G06K 11/06

(52) U.S. Cl. 178/18.01

(57) ABSTRACT

A touch-based input device is disclosed comprising a touch-sensing element configured to register a touch on said touch-sensing element and at least one sensor operably connected to the touch-sensing element and configured to measure said touch, wherein said sensor is further configured to generate a signal corresponding to the detection of said touch. The input device further comprises a dynamic component operably connected to the touch-sensing element, said dynamic component configured to apply a dynamic force to the touch-sensing element without registering a detectable touch on said touch-sensing element while concurrently allowing detection of an external stimulus on the touch-sensing element.

### PRIORITY CLAIM

This application claims the benefit of U.S. Provisional Application No. 60/931,400 filed on May 22, 2007 entitled “User Interfaces and Utilities Operable with a Force-Based Input Device” the entirety of which is incorporated herein by reference.

### FIELD OF THE INVENTION

The present invention relates to input devices, touch panels, computer displays and the like, and more particularly to the various user interfaces, namely physical interfaces, utilities, attachments, etc. that may be operable with and/or supported about these.

### BACKGROUND OF THE INVENTION AND RELATED ART

Input devices (e.g., a touch screen or touch pad) are designed to detect the application of an object and to determine one or more specific characteristics of or relating to the object as relating to the input device, such as the location of the object as acting on the input device, the magnitude of force applied by the object to the input device, etc. Examples of some of the different applications in which input devices may be found include computer display devices, kiosks, games, point of sale terminals, vending machines, medical devices, keypads, keyboards, and others.

Currently, there are a variety of different types of input devices. Some examples include resistive-based input devices, capacitance-based input devices, surface acoustic wave-based devices, force-based input devices, infrared-based devices, and others. While providing some useful functional aspects, each of these prior related types of input devices suffer in one or more areas.

Resistive-based input devices typically comprise two conductive plates that are required to be pressed together until contact is made between them. Resistive sensors only allow transmission of about 75% of the light from the input pad, thereby preventing their application in detailed graphic applications. In addition, the front layer of such devices is typically comprised of a soft material, such as polyester, that can be easily damaged by hard or sharp objects, such as car keys, pens, etc. As such, this makes them inappropriate for most public-access applications.

Capacitance-based input devices operate by measuring the capacitance of the object applying the force to ground, or by measuring the alteration of the transcapacitance between different sensors. Although inexpensive to manufacture, capacitance-based sensors typically are only capable of detecting large objects as these provide a sufficient capacitance to ground ratio. In other words, capacitance-based sensors typically are only capable of registering or detecting application of an object having suitable conductive properties, thereby eliminating a wide variety of potential useful applications, such as the ability to detect styli and other similar touch or force application objects. In addition, capacitance-based sensors allow transmission of about 90% of input pad light.

Surface acoustic wave-based input devices operate by emitting sound along the surface of the input pad and measuring the interaction of the application of the object with the sound. In addition, surface acoustic wave-based input devices allow transmission of 100% of input pad light, and don't require the applied object to comprise conductive properties. However, surface acoustic wave-based input devices are incapable of registering or detecting the application of hard and small objects, such as pen tips, and they are usually the most expensive of all the types of input devices. In addition, their accuracy and functionality is affected by surface contamination, such as water droplets.

Infrared-based devices are operated by infrared radiation emitted about the surface of the input pad of the device. However, these are sensitive to debris, such as dirt, that affect their accuracy.

Each of these types of input devices also suffers from their inability to provide different utilities and interfaces other than simply a touch surface that might have various graphics or other indicia thereon. As such, these input devices tend to be very generic in both their function and appearance.

### SUMMARY OF THE INVENTION

In light of the problems and deficiencies inherent in the prior art, the present invention seeks to overcome these by providing a touch-based input device capable of operably supporting one or more integrated or add-on interfaces or utilities, referred to herein as functional attachments and/or dynamic components, about a force-sensing element, which may be customizable and which provide the input device with more stimulating and enhanced or improved user interface capabilities and functionality, such as added features, capabilities, aesthetics, etc.

In accordance with the invention as embodied and broadly described herein, the present invention resides in a touch-based input device comprising a touch-sensing element configured to receive an applied force and at least one sensor operable with the touch-sensing element to detect said applied force; the sensor being configured to generate a signal corresponding to the detection of said applied force. The touch-based input device further comprises one or more dynamic components moveable about the touch-sensing element and operable to apply a dynamic force on the touch-sensing element. The dynamic component may be self-contained, meaning no external forces (e.g., input from a user) are required to cause movement within or of the dynamic component. Indeed, in many embodiments, the dynamic component is movable about the touch-sensing element under its own power or influence. Alternatively, the dynamic component may be configured such that a force is registered upon movement of the dynamic component about the touch-sensing element, which forces may be accounted for by operating software.

In one aspect of the invention, the touch-based input device comprises a dynamic component acting on said touch-sensing element, wherein the dynamic component is adapted to act on the touch-sensing element without causing a force to be detected or registered about the touch-sensing element, and wherein the touch-sensing element is adapted to concurrently receive an applied force and allow detection of an external stimulus acting at any location on the touch-sensing element, including anywhere within the area of travel by the dynamic component, as well as on the dynamic component itself in many cases.

As noted herein, in another aspect of the invention, the dynamic component acting on the surface of the touch-sensing element may comprise running water moving about the surface of the touch-sensing element. Again, the touch-sensing element may operate to receive an applied force from an external stimulus acting on the touch-sensing element, although at least partially covered with water.

The present invention also resides in a touch-based input device comprising a touch-sensing element configured to receive an applied force; at least one sensor operable with the touch-sensing element to detect the applied force, the sensor being configured to generate a signal corresponding to the detection of the applied force; and a self-propelled dynamic component moveable about a surface of said touch-sensing element without registering a detectable force on said touch-sensing element. In this case, the touch-sensing element is adapted to allow concurrent detection of an external stimulus on the touch-sensing element. In one aspect, the external stimulus may be detected even within a boundary traced by the movement of the self-propelled dynamic component.

In an additional embodiment, the present invention also resides in a touch-based input device comprising a touch-sensing element configured to receive an applied force; at least one sensor operable with the touch-sensing element to detect the applied force, the sensor being configured to generate a signal corresponding to the detection of the applied force; and a dynamic component moveable about a surface of the touch-sensing element and operable to apply a dynamic force on the touch-sensing element. In this aspect, the sum of non-gravitational forces from the dynamic component acting on the touch-sensing element may be configured to be substantially zero.

In an additional embodiment of the present invention, a force-based input device is disclosed comprising a first structural element supported in a fixed position; a second structural element operable with the first structural element, and dynamically supported to be movable with respect to the first structural element to define a force-sensing element configured to displace under an applied force; a plurality of isolated beam segments joining the first and second structural elements, the isolated beam segments being operable to transfer forces between the first and second structural elements resulting from displacement of the force-sensing element; at least one sensor operable to measure strain within each of the isolated beam segments resulting from the transfer of forces and the displacement of the force-sensing element; and a dynamic component moveable about a surface of the touch-sensing element and operable to apply a dynamic force on said touch-sensing element.

The present invention also resides in a method of operating a touch-based input device having a touch-sensing element, the method comprising obtaining a touch-sensing element, the touch-sensing element being operable to detect an applied force and facilitate determination of the location of the applied force with respect to the touch-sensing element; operating a self-propelled dynamic component supported about a surface of the touch-sensing element, the dynamic component being moveable about the touch-sensing element and operable to apply a dynamic force on the touch-sensing element; and applying an external force to the touch-sensing element to register an applied force and to perform an intended function.

Additionally, the present invention also resides in a method of manufacturing a dynamic component operable with a touch-sensing element, comprising providing a touch-sensing element operable to detect an applied force and facilitate determination of the location of the applied force with respect to the touch-sensing element; and supporting a self-propelled dynamic component about the touch-sensing element, the dynamic component being moveable about the touch-sensing element and operable to apply a dynamic force on the touch-sensing element. In this aspect of the invention, the self-propelled dynamic component is supported, such that the sum of non-gravitational forces from the dynamic component acting on the touch-sensing element is substantially zero.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a force-based sensing device in accordance with one exemplary embodiment of the present invention;

FIG. 2 illustrates a perspective view of the force-based sensing device of FIG. 1 as coupled to a processing system used to perform the necessary processing steps to determine the location of an applied force;

FIG. 3a illustrates a top view of a force-based input device having a dynamic component operable with a force-sensing element, in accordance with one exemplary embodiment of the present invention;

FIG. 3b illustrates a side view of the force-based input device of FIG. 3a;

FIG. 4a illustrates a top view of a force-based input device having a wiper blade assembly operable with a force-sensing element, in accordance with one exemplary embodiment of the present invention;

FIG. 4b illustrates a side view of the force-based input device of FIG. 4a;

FIG. 5a illustrates a top view of a force-based input device having water moving across a surface of the force-sensing element, in accordance with one exemplary embodiment of the present invention; and

FIG. 5b illustrates a side view of the force-based input device of FIG. 5a.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes an input device having one or more functional attachments and/or components that are supported about a sensing or touch-sensing element of the input device. The functional attachments/components are designed and intended to expand the functionality of the input device, as well as to introduce and provide new and exciting user interfaces that are operable with the sensing element of the input device. The functional attachments/components may provide an aesthetic function, a utility function, a tactile function, or a combination of any of these and others. Indeed, rather than simply providing a planar, rigid touch surface as found in prior related input devices, particularly those that are not of the force-based type, the present invention introduces and creates user interfaces not possible with other input devices. The concept of incorporating a wide variety of “dynamic components” is, in general, one of the unique features of the present invention force-based input device.

Generally speaking, the dynamic functional attachments or components of the present invention can be attached or mounted to either side of a force-sensing or touch-sensing element, or to a projected panel operable with a force or touch-sensing element, using any suitable means. In addition, the dynamic functional attachments or components may be made and configured to be operable with one or more holes or voids formed in the touch-sensing element. The ability to have voids or penetrations within the touch-sensing element, such as something as simple as a clear through-hole, is discussed in more detail in U.S. patent application Ser. No. ______, filed concurrently herewith, and entitled “Force-Based Input Device with a Boundary Defining a Void,” (Attorney Docket No. 02089-32356.NP4), which application is incorporated herein by reference in its entirety. Moreover, the present invention dynamic functional attachments may be made to operate with one or more static functional attachments to even further enhance the user interface of the touch-based input device, such as projected functional attachments or panels, interchangeable and/or removable static attachments, etc., allowing for simple and quick reconfiguration of the user interface. Examples of static attachments operable with a touch-based input device are disclosed in U.S. application Ser. No. ______, filed concurrently herewith, and entitled, “Touch Sensitive Input Device Providing a Reconfigurable User Interface,” (Attorney Docket No. 02089-32356.NP3), which application is incorporated by reference herein in its entirety.

It is intended that the touch-based input devices of the present invention be operable with different types of functional attachments or components. Generally speaking, functional attachments may be categorized into two broad types. In a first type, the functional attachments may be sensed by the force-sensing element, wherein the functional attachment or component functions to transfer a force to the force-sensing element causing the force-sensing element to displace and register the force (i.e., causing the input device to determine the location of the applied force). In a second type, the functional attachments or components are configured in a manner so as to not be sensed by the force-sensing element. In this case, the functional attachments or components provide one or more functions that do not cause a registered force. That is, although forces may be applied to the touch-sensing element, the system is configured to account for such forces internally (e.g., through calibration means).

With each of the first and second types, the functional attachments or components may be further categorized into static (those with no moving parts) or dynamic (those with one or more moving parts to perform a function or enhance the user interface) functional attachments or components. In a static embodiment, the functional attachment has no moving parts, but may nonetheless be used to enhance or reconfigure a user interface or to provide one or more functional purposes, provide aesthetic enhancements, or both. Examples of static functional attachments include, but are no way limited to, monolithic or non-moving buttons or keys, speakers, architectural features (filigrees, accents, etc.), projected panels, and others. In a dynamic embodiment, the functional attachment may comprise one or more moving parts that operate to perform one or more functions, provide purely aesthetic enhancements, or both. Examples of dynamic functional attachments include, but are in no way limited to, motors, fans, wipers, blinds, tactile or depressible buttons or keys, jog wheels, sliders to adjust volume, speed, etc., switches, retractable pins or rods, hinged elements, and others. From the description herein, those skilled in the art will recognize that many other specific static or dynamic functional attachments/components that may be sensed or not sensed by the force-sensing element are possible, and that may be used in conjunction with one another to provide a more stimulating and interactive user interface.

Under certain circumstances it is possible to dispose one or more dynamic components about the touch-based input device without adversely affecting the function of the input device, but yet allowing the dynamic component to become sensitive to an applied force such that when an external force is applied to the dynamic component, such force is detected and registered by the touch-sensing element. Indeed such dynamic components can add utility to the input device in that the input device can report a user touching the dynamic component, as well as determine the location and/or magnitude of the user's applied force acting on the dynamic component. This may be more particularly applicable to force-based input devices. As noted herein, force-based input devices work by measuring the force applied to the force-sensing element by means of a plurality of strategically arranged force sensors that are operable with the force-sensing element. The force sensors are arranged such that all of the force components in at least one direction applied to the input device by a user's touch are transmitted to and measured by the force sensors. The distribution of the forces among the sensors is analyzed to determine the location and/or magnitude of the applied force.

A dynamic component operable about a touch-sensing or force-sensing element that does not generate any force components transferred to the supporting sensors during movement, will have no effect on the location determining function of the input device. In one aspect, this is made possible by containing and balancing all forces of the dynamic component within the touch-based input device (no application of external forces), thus resulting in no net effect on the force sensors. For example, one exemplary dynamic component may have a spring-loaded arm that presses against one surface of the touch-sensing element. If the arm and spring are also attached or mounted to the force panel (say via a mount located on an opposite surface of the touch-sensing element), they produce an equal and opposite reaction force with a zero net force. This is a consequence of the principle that the sum of forces and moments in an un-accelerated system is zero. That is, where all of the forces resulting from the dynamic components are contained entirely within the touch-sensing element, the resulting force will have no net effect on the force sensors operable with the touch-sensing element. In this manner, the equal and opposing forces cancel each other out thereby precluding the registration of a net force on the touch-sensing element.

In one aspect of the invention, a dynamic component may have internal movable parts with appreciable mass. If the dynamic component accelerates any internal mass (e.g., by means of an internal motor) it may generate a reaction force that might be measured by the force sensors. The amount of disruption to the touch-sensing surface depends on the amount of mass, the magnitude of the acceleration, the direction of the acceleration of the mass and the duration of the acceleration. Accelerations within the plane of the force sensors will have no net effect. Movements of short duration can also be accounted for (i.e., effectively ignored) by the associated processing/software/calculating system.

Input devices and their attachments interact with the earth's gravitational field. The mass of the input device's touch-sensing element has weight due to gravity that may be measured by the force sensors, depending on the input device's orientation (e.g. vertical or horizontal with respect to direction of gravity). Force-based input devices have various means of subtracting the static baseline that results from gravitational effects, so that the touch estimation can be based only on the forces imparted to the input device by the user. A dynamic component made to operate with an input device may significantly alter the input device's mass distribution by changing the location of one or more of its movable parts. If the center of mass of the input device relative to the force sensors is changed, the distribution of gravitationally induced forces will change and, unless compensated for, cause the reported touch location to be inaccurate, cause false touches to be reported, or prevent touches from being reported.

In one embodiment of the present invention wherein the input device is configured in a horizontal orientation, only changes in the center of mass of a dynamic component projected in the plane of the input device (i.e., the x-y plane) are significant. Changes in the center of mass in the direction normal (z-direction) to the input device (i.e., the sensing direction of the force sensors) will be ignored. Changes in mass distribution due to moving parts in dynamic components that are balanced, (i.e., the motions are such that the center of mass of the component remains fixed) are not significant. Additionally, in many cases the moving mass will be so small that its effects are negligible. In an additional aspect where the input device is configured in a vertical orientation, changes in the center of mass in the x-y plane will be ignored and changes in the center of mass in the z-direction may require calibration, if the change is such that a resulting moment force on the input device is created.

Dynamic components that do generate significant forces in the input device's force sensors due to their operation can still be made so as to not adversely affect the touch sensing function of the input device. In general terms, the input device will be “aware” of the motions of the dynamic components and can compensate appropriately. This compensation scheme can be of various forms. In one exemplary embodiment, a force-based touch panel can be configured so that any forces created on the force-sensing element and any resulting strains measured within the isolated beam segments can be removed during signal processing, either through dynamic measurement of these forces during operation or through prior measurement of repeatable forces being removed algorithmically. An example of the latter would be a reciprocal windshield wiper where the characteristic lateral force is measured and subtracted from the sensed signals in coordination with the movement of the windshield wiper.

Touches can be ignored during the times when the dynamic component moves. This can be accomplished either by disabling touch reporting or discontinuing processing by the input device's processing mechanism. Alternatively, the user application can ignore touches reported by the input device during operation of the dynamic component. These methods are particularly appropriate for inertial forces stemming from significant acceleration of one or more parts of the dynamic component. In the case of gravitational effects due the dynamic component, a new set of baseline values for the input device's force sensors may be established immediately following any movement of the dynamic component, assuming that the user does not touch the panel or the attachment at that time. The new baseline values will account for the changed position of the dynamic component.

In the case of gravitational effects, if the center of mass of the dynamic component has a reasonable finite number of known states, the effect of changing the center of mass can be corrected by calibration. The outputs of the input device's force sensors are noted while the dynamic component is placed in each of its states or positions. This establishes a different baseline sensor reading for each dynamic component state. The appropriate baseline readings are subtracted from the sensor outputs depending on the known state of the dynamic component. This baseline may be in addition to any other estimated baseline that the touch panel employs. The baseline changes may also be calculated from known characteristics of the dynamic component. Additionally, it may be that the changes in forces due to the motion of the dynamic components parts is small enough compared with the desired performance of the touch panel that they can be ignored.

Dynamic functional attachments/components that are intended to be sensed by the force-sensing element are to be configured so that they create an adequate normal or z-axis force that can be detected as they move or are moved. One example of such a dynamic functional attachment is a push button or key having a snap-dome feedback mechanism configured to provide tactile feedback to the operator.

The present invention provides several significant advantages over prior related input devices and the user interfaces operable with these. Many advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

### Input Device

The present invention dynamic components are intended to be operable with input devices, and particularly with force-based input devices. While specific reference is made herein to a particular configuration of a force-based input device, it is understood that any touch-based input device is contemplated for use herein comprising a touch-sensing element (including force sensors) which generates a signal in response to a touch from an external stimulus. Although force-based input devices are more particularly set forth herein, examples of other types of touch-based input devices include, but are not limited to, resistive-based input devices, capacitance-based input devices, surface acoustic wave-based devices, and infrared-based devices.

In one aspect of the invention, a force-based input device comprises a first, mounted or stationary structural support member, and a second, dynamic structural support member that moves or displaces with respect to the first structural support member, wherein the second, dynamic structural support member comprises a force-sensing element designed to receive and register forces applied to its surface, either directly or indirectly. Direct application of force would mean that the force is acting directly on the surface of the force-sensing element. Indirect application of force would mean that the force is acting on another object or surface, but that the applied force is sufficiently transferred to the force-sensing element to cause the force to register as if it were applied directly to the force-sensing element itself. For instance, in the case of a functional attachment that is sensed by the force-sensing element, the force-based input device is capable of registering and determining a location of a force that is applied on the functional attachment. The force acting on the functional attachment, and that is transferred to the force-sensing element, registers about substantially the same coordinates as if the force were being applied directly to the force-sensing element. This is made possible by the configuration of the force-based input device being used.

Within the force-based input device, the force-sensing element may comprise many different types and configurations. For example, the force-sensing element may comprise any of those described in U.S. application Ser. No. 11/402,694, filed Apr. 11, 2006, and entitled, “Force-based Input Device;” as well as U.S. application Ser. No. 11/888,673, filed Jul. 31, 2007 and entitled, “Force-Based Input Device Having an Elevated Contacting Surface;” and U.S. application Ser. No. 12/002,334, filed Dec. 14, 2007, and entitled, “Force-Based Input Device Having a Modular Sensing Component,” each of which are incorporated by reference in their entirety herein.

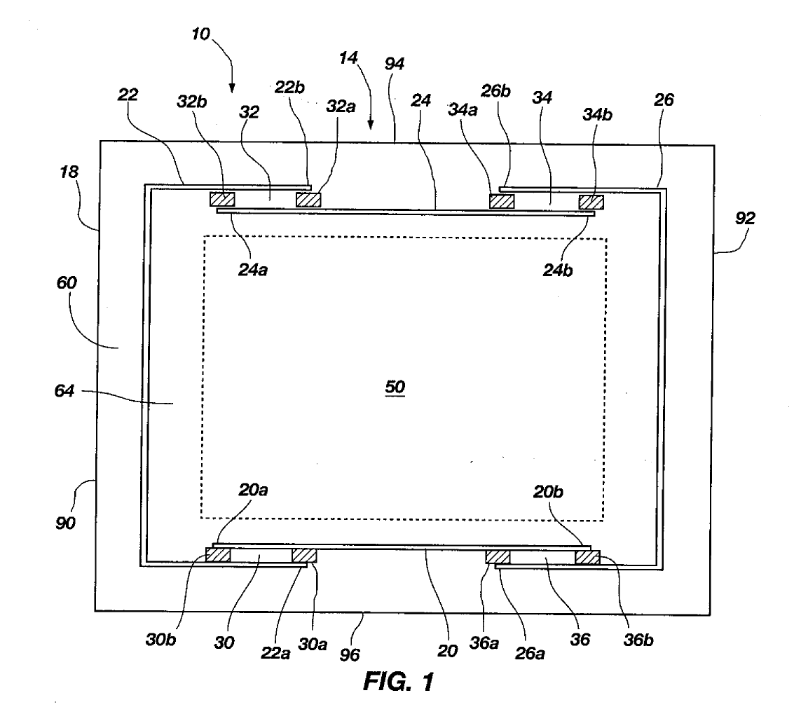

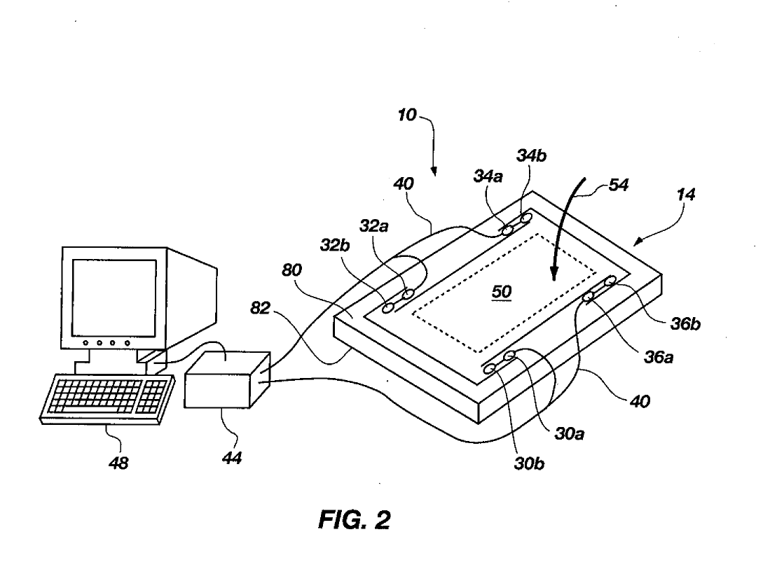

In one exemplary embodiment, with reference to FIGS. 1 and 2, shown is a force-based input device 10. The input device 10 can have a first structural member in the form of a base support 14 having an outer periphery 18. A plurality of apertures 20, 22, 24, and 26 can be formed in the base support 14 within the periphery 18. The apertures 20, 22, 24, and 26 can be located along the periphery 18 and can circumscribe or define a second structural member in the form of an input pad or force-sensing element 50 that is movable with respect to the first structural member or base support 14 in response to an applied load.

The plurality of apertures can also define a plurality of isolated beam segments, 30, 32, 34, and 36, near the corners of, and parallel to the sides of the force-sensing element 50. Two sensors (see sensors 30a, 30b, 32a, 32b, 34a, 34b, 36a and 36b) can be attached along each isolated beam segment 30, 32, 34, and 36, respectively. The sensors 30a, 30b, 32a, 32b, 34a, 34b, 36a and 36b are configured to detect and measure a force applied to the force-sensing element 50. In addition, the sensors 30a, 30b, 32a, 32b, 34a, 34c, 36a and 36b are configured to output an electronic signal through a transmission device 40 attached or otherwise related to the sensors 30a, 30b, 32a, 32b, 34a, 34b, 36a and 36b, which signal corresponds to the applied force as detected by the sensors.

In one exemplary embodiment, the sensors 30a, 30b, 32a, 32b, 34a, 34c, 36a and 36b each comprise a strain gage configured to measure the strain within or across each of the respective isolated beam segments 30, 32, 34, and 36. Moreover, although each isolated beam segment 30, 32, 34, and 36 is shown comprising two sensors located or disposed thereon, the present invention is not limited to this configuration. It is contemplated that one, two or more than two sensors may be disposed along each of the isolated beam segments depending upon system constraints and other factors. In addition, it is contemplated that the sensors may be comprised of the beam segments themselves, if appropriately configured. The sensors are discussed in greater detail below.

The transmission device 40 is configured to carry the sensors' output signal to one or more signal processing devices, shown as signal processing device 44, wherein the signal processing devices function to process the signal in one or more ways for one or more purposes. For example, the signal processing devices may comprise analog signal processors, such as amplifiers, filters, and analog-to-digital converters. In addition, the signal processing devices may comprise a micro-computer processor that feeds the processed signal to a computer, as shown in FIG. 2. Or, the signal processing device may comprise the computer 48, itself. Still further, any combination of these and other types of signal processing devices may be incorporated and utilized. Typical signal processing devices are known in the art and are therefore not specifically described herein.

Processing means and methods employed by the signal processing device for processing the signal for one or more purposes, such as to determine the coordinates of a force applied to the force-based touch pad, are also known in the art. Various processing means and methods are discussed in further detail below.

With reference again to FIGS. 1 and 2, the base support 14 is shown comprising a substantially flat, or planar, pad or plate. The base support 14 can have an outer mounting surface 60 and an inner mounting surface 64 that can lie essentially within the same plane in a static condition. The outer mounting surface 60 can be located between the periphery 18 and the apertures 20, 22, 24, and 26. The inner mounting surface 64 can be located between the force-sensing element 50 and the apertures 20, 22, 24, and 26. The isolated beam segments 30, 32, 34, and 36 can connect the inner mounting surface 64 with the outer mounting surface 60. The outer mounting surface 60 can be mounted to any suitably stationary mounting structure configured to support the input device 10. The force-sensing element 50 can be a separate structure mounted to the inner mounting surface 64, or it may be configured to be an integral component that is formed integrally with the inner mounting surface 64. In the embodiment where the force-sensing element is a separate structure, one or more components of the force-sensing element can be configured to be removable from the inner mounting surface. For example, the force-sensing element 50 may comprise a large aperture formed in the base support 14, and a removable force panel configured to be inserted and supported within the aperture, which force panel functions to receive the applied force thereon from either direction.

The base support 14 can be formed of any suitably inelastic material, such as a metal, like aluminum or steel, or it can be formed of a suitably elastic, hardened polymer material, as is known in the art. In addition, the base support 14 may be formed of glass, ceramics, and other similar materials. The base support 14 can be shaped and configured to fit within any type of suitable interface application. For example, the base support can be configured as the viewing area of a display monitor, which is generally rectangular in shape. In addition, the base support 14 can be configured to be relatively thin so that the touch surface of the force-sensing element of the base support is only minimally offset from the viewing area of a display monitor, thereby minimizing distortion due to distance between the force-sensing element and the display monitor.

It is noted that the performance of the input device may be dependent upon the stiffness of the outer portion or outer mounting surface of the base support 14. As such, the base support 14, or at least appropriate portions thereof, should be made to comprise suitable rigidity or stiffness so as to enable the input device to function properly. Alternatively, instead of making the base support 14 stiff, the base support 14, or at least a suitable portion thereof, may be attached to some type of rigid support. Suitable rigidity functions to facilitate more accurate input readings.

The force-sensing element 50 can be a substantially flat, or planar, pad or plate and can lie within the same plane as the base support 14. The force-sensing element 50 can be circumscribed by the apertures 20, 22, 24, and 26.

The force-sensing element 50 is configured to displace in response to various stresses induced in the force-sensing element 50 resulting from application of a force, shown as arrow 54 in FIG. 2, acting on the force-sensing element 50. The force-sensing element 50 is further configured to transmit the stresses induced by the applied force 54 to the inner mounting surface 64 and eventually to the isolated beam segments 30, 32, 34, and 36 where resulting strains in the isolated beam segments are induced and measured by the one or more sensors.

The base support 14 and force-sensing element 50 can have a first side 80 and a second side 82. The present invention force-based input device 10 advantageously provides for the application of force to either the first or second sides 80 and 82 of the force-sensing element 50, and the force-sensing element 50 may be configured to displace out of the plane of the base support 14 in either direction in response to the applied force 54.

The force-sensing element 50 can be formed of any suitably rigid material that can transfer, or transmit the applied force 54. Such a material can be metal, glass, or a hardened polymer, as is known in the art.

The isolated beam segments 30, 32, 34, and 36 can be formed in the base support 14, and may be defined by the plurality of apertures 20, 22, 24, and 26. The isolated beam segments 30, 32, 34, and 36 can lie essentially in the same plane as the base support 14 and the force-sensing element 50 when in a static condition. In some embodiments, the apertures 20, 22, 24, and 26 may be configured to extend all the way through the base support 14. For example, the apertures 20, 22, 24, and 26 can be through slots or holes. In other embodiments, the isolated beam segments 30, 32, 34 and 36 may be configured to extend only partially through the base support 14.

As illustrated in FIG. 1, the isolated beam segment 32 can be formed or defined by the apertures 22 and 24. Aperture 22 can extend along a portion of the periphery 18 and have two ends 22a and 22b. The aperture 24 can extend along another portion of the periphery and have two ends 24a and 24b. Portions of the two apertures 22 and 24 can extend along a common portion of the periphery 18 where one end 22b of aperture 22 overlaps an end 24a of aperture 24. The two ends 22b and 24a, and the portions of the apertures 22 and 24 that extend along the common portion of the periphery 18, can be spaced apart on the base support 14 a pre-determined distance. The portion of the aperture 22 that extends along the common portion of the periphery 18 can be closer to the periphery 18 than portion of the aperture 24 that extends along the common portion of the periphery 18. The area of the base support 14 between the aperture 22 and the aperture 24, and between the end 22b and the end 24a, can define the isolated beam segment 32.

The isolated beam segments 30, 34, and 36 can be similarly formed and defined as described above for isolated beam segment 32. Isolated beam segment 30 can be formed by the area of the base support 14 between the apertures 24 and 20, and between the ends 24a and 20a. Isolated beam segment 34 can be formed by the area of the base support 14 between the apertures 24 and 26, and between the ends 24b and 26b. Isolated beam segment 36 can be formed by the area of the base support 14 between the apertures 26 and 20, and between the ends 26a and 20b. Thus, all of the isolated beam segments can be defined by the various apertures formed within the base support 14. In addition, the isolated beam segments may be configured to lie in the same plane as the plane of the force-sensing element 50 and base support 14, as noted above.

The plurality of apertures 20, 22, 24, and 26 can nest within each other, wherein apertures 22 and 26 extend along the sides 90 and 92 of the rectangular base support 14, and can turn perpendicular to the short sides 90 and 92 and extend along at least a portion of the sides 94 and 96 of the base support 14. Apertures 20 and 24 can be located along a portion of the sides 94 and 96 of the base support 14 and closer to the force-sensing element 50 than apertures 22 and 26. Thus, apertures 20 and 24 can be located or contained within apertures 22 and 26. Stated differently, the apertures may each comprise a segment that overlaps and runs parallel to a segment of another aperture to define an isolated beam segment, thus allowing the isolated beam segments to comprise any desired length.

In another exemplary embodiment similar to that shown in FIG. 1, that the force-sensing element may be located about the perimeter or periphery of the input device with the inner and outer mounting surfaces being positioned inside or interior to the force-sensing element. In other words, the force-based input device may be considered to comprise a structural configuration that is the inverse of the configuration shown in FIG. 1. This further illustrates that the present invention broadly contemplates a first structural element supported in a fixed position, and a second structural element operable with the first structural element, wherein the second structural element is dynamically supported to be movable with respect to the first structural element to define a force-sensing element configured to displace under an applied force.

### Dynamic Components

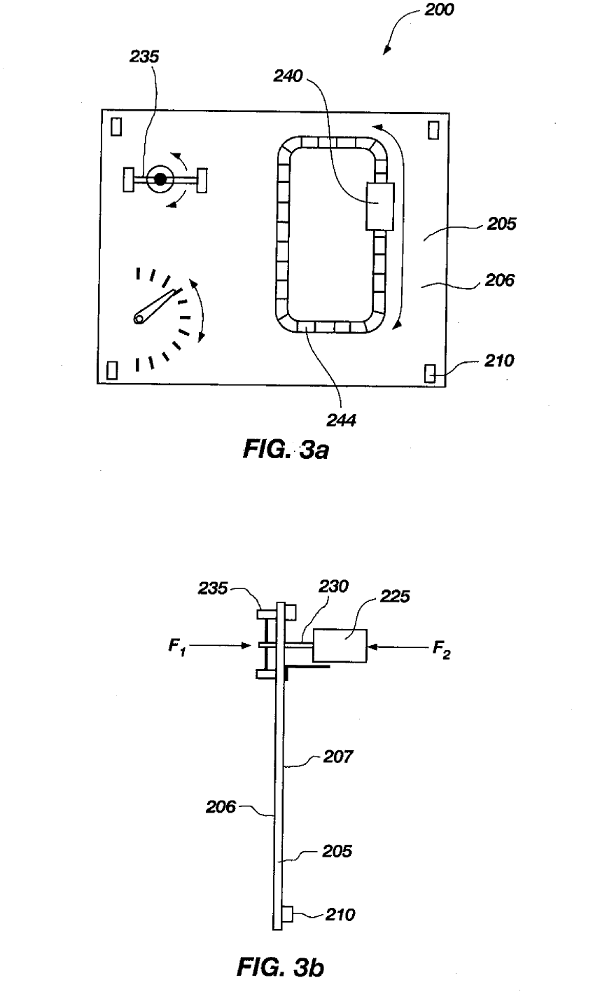

With reference to FIGS. 3a and 3b, illustrated is a force-based input device in accordance with one exemplary embodiment of the present invention. As shown, the force-based input device 200 comprises a force-sensing element 205 and a force sensor 210. The present invention force-based input device may comprise many different dynamic components. In one aspect, the dynamic components are moveable about a surface of the force-sensing element 205. The dynamic components are self-propelled about said surface. In other words, no external force is needed or applied to the dynamic component to propel the component (e.g., a mechanical force from a person or device that is not supported about the force-based input device). FIGS. 3a and 3b illustrate a sample of one of the unique possibilities that can be created with the dynamic components. These are made possible by the force-based technology of the input device, such as the technology described in FIGS. 1 and 2 and the above-referenced and incorporated applications.

The force-sensing element 205 comprises a static mass. Use of one or more dynamic components on the input device increases the overall static mass of the input device. However, because this static mass is constant, the increase in static mass is intended to be accounted for during calibration and recalibration of the force-based input device, whether manual or automatic. While the overall static mass of the input device may fluctuate with the addition, removal or relocation of a dynamic component, the input device can be recalibrated to account for this fluctuation of static mass and to enhance the accuracy of the reported readings from the input device with respect to the location of an externally applied force.

As noted further below, a dynamic component may have one or more moveable parts with appreciable mass. If the dynamic components accelerate any mass (e.g., by means of an internal motor) it will generate a reaction force that might be measured by the input device's force sensors. The amount of disruption to the input device depends on the amount of mass, the magnitude of acceleration, the direction of the acceleration of the mass and the duration of the acceleration. Accelerations within the plane of the touch sensors will have no net effect.

With reference again to FIGS. 3a and 3b, a motor 225 is mounted to a rear surface 207 of the force-sensing element 205. The motor 225 may comprise an electric motor, a pneumatic motor, a hydraulic motor, or any other suitable device capable of generating motion. The motor 225 is coupled to a shaft 230 which is disposed perpendicular to the surface of the force-sensing element 205 and inserted through a void present in the force-sensing element 205. The shaft 230 is operably coupled to an axle and wheel assembly 235 which is disposed substantially parallel to a front surface 206 of the force-sensing element 205. Activation of the motor 225 causes the rotation of a shaft 230 and an axle and wheel assembly 235 operably coupled thereto. The axle and wheel assembly 235 is not intended to register a force as it is rotated about the front surface 206, even though the wheels are in contact with and apply a force normal to the force-sensing element 205. As noted in more detail above, the applied force is not registered by the force-sensing element 205 because all the forces generated are constrained to the force-sensing element 205 to which the motor 225 is mounted and on which the wheels run. That is, because the motor 225 and the wheel and axle assembly 235 are constrained to the force-sensing element 205 and are integrally connected to one another, each creates equal and opposing forces that cancel each other out thereby precluding the registration of a net force on the force-sensing element 205. While a static mass of the motor 225 and wheel and axle assembly 235 may initially register a force on the force-sensing element 205, that static mass may be calibrated out of the input device as noted in more detail herein. Advantageously, while the force applied to the front surface 206 of the force-sensing element is not registered by the force-sensing element, an external force concurrently applied on either the front surface 206 or the rear surface 207 (such as a force applied by a finger) of the force-sensing element 205 is still measured by and located on the force-sensing element 205. At least in part, this is because an equal and opposite force is not being applied to the alternate surface (the rear surface 207) of the force-sensing element. In this manner, the dynamic component may operate without having any net effect on the force sensing capabilities of the input device.

In an additional aspect of the invention, the dynamic component shown in FIGS. 3a and 3b, fails to register a net force on the force-sensing element, because the dynamic components (i.e., the axle and wheel assembly 235) in contact with and moving about the front surface 206 of the force-sensing element 205 are centered around shaft 230. In this manner, the center of mass of the dynamic component with respect to the plane of the force-sensing element is fixed. As noted, in this embodiment, the center of mass of the dynamic component normal to the force-sensing element 205 is fixed. However, in other embodiments, movement of the center of mass normal to the force-sensing element 205 will not result in registration of a force by the force-sensing element so long as the force-sensing element is configured in a horizontal orientation.

Additionally, no detectable inertia is being generated during rotation. There may be some degrees of inertia upon starting and stopping the motor, but if the motor rotational speed is held constant then the inertia falls to zero, or at least only registers negligible amounts. This is because the major forces transmitted to the force sensors due to angular rotation are coplanar with the panel and thus should have not effect on the force sensors' ability to detect and locate touches. In one aspect of the invention, the acceleration of any dynamic components may be limited to a predetermined maximum level so as to preclude the registration of a resulting force on the force-sensing element 205. In one aspect of the invention, said predetermined maximum level is a function of the mass of the dynamic components and rate of acceleration.

It is understood and contemplated herein that any type of functional attachment (or other force applied to the force-sensing element) may be used to control the speed of the motor. Using signal processing software, the magnitude of the applied force can be related to the speed of the motor to facilitate selective adjustments. Also shown is a gauge showing the velocity of the wheel and axle assembly 235 as it turns about its center of mass 236. The gauge may comprise a gauge mounting component mounted to the alternate surface of the force-sensing element. This particular motor and controller assembly illustrates how the present invention force-based input device can receive and process different magnitudes of applied force to vary a desired functionality according to the change in force, such as a change in velocity of the dynamic component.

In another aspect, shown in FIG. 3a, the present invention may comprise a dynamic component in the form of a shifting mass movable about the force-sensing element 205. For example, a mass 240 may be movable along a track 244 supported about the surface of the force-sensing element 205. In this embodiment, the center of mass of the dynamic component changes in the x-y direction, with respect to the force sensors, depending upon the location of the dynamic component. As the dynamic component moves about the surface, a force is registered by the force-sensing element (including force sensors), which force may be predicted and accounted for in the software so as to not interfere with the normal operation of the input device.

In an additional embodiment (not shown), the force-based input device 200 further comprises a dynamic component having components that both are and are not intended to be sensed by the force-sensing element 210. In one exemplary embodiment, a dynamic component may comprise a projected structural element mounted to the force-sensing element 210 via bolts, which projected structural element comprises an input surface and one or more touch zones designated thereon. The projected structural element functions in a similar manner as the projected functional attachments and discussed above, and may be configured to be sensed by the force-sensing element 210.

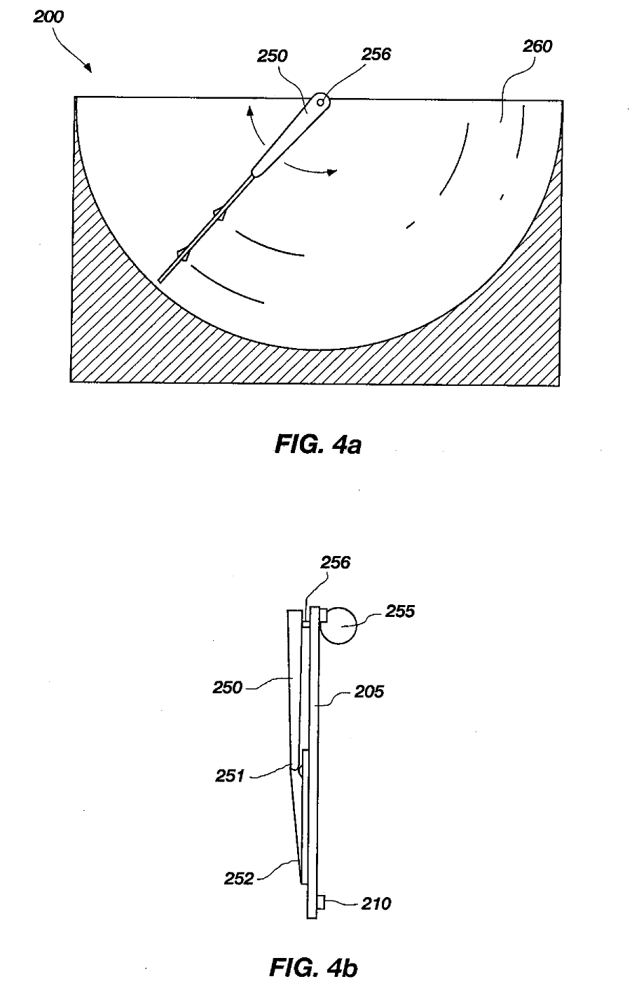

With reference now to FIGS. 4a and 4b, an additional embodiment of the present invention, a wiper blade assembly 250 disposed on a force-based input device 200 is shown. The force-based input device 200 comprises a force-sensing element 205 and at least one force sensor 210 configured to detect a force applied to the force-sensing element 205. The wiper blade assembly comprises a motor 255 mounted to a rear surface 207 of the force-sensing element 205 with a shaft 256 operably connected to the motor 255 and disposed perpendicular to the force-sensing element 205 through a void present within the force-sensing element 205. A pivoting arm 251 having a wiper blade 252 disposed in contact with a front surface 206 of the force-sensing element is operably coupled to shaft 256 and configured to move laterally across a front surface 206 of the force-sensing element. In this manner, fluids and/or other debris that may accumulate on the front surface 206 of the force-sensing element 205 may be removed. Configured in this arrangement, a substantially constant force is applied by the wiper blade 252 to the front surface of the force-sensing element 205.

As with the embodiment illustrated in FIGS. 3a and 3b, the force applied by the wiper blade 252 to the front surface 206 of the force-sensing element 205 is not registered by the force-sensing element 205. As with the wheel and axle assembly of FIG. 3, the force applied by the wiper blade 252 to the front surface 206 of the force-sensing element 205 is countered by an equal and opposite force applied by the motor 255 mounted on the rear surface 207 of the force-sensing element 205. The static mass of the wiper blade assembly 250 is accounted for as with other static masses described in more detail herein. Materially different from the wheel and axle assembly of FIGS. 3a and 3b, the center of mass of the wiper blade assembly 250 is not fixed relative to the plane of the force-sensing element 205. Rather, the center of mass moves laterally across the force-sensing element 205 in a finite, predictable pattern during motion of the wiper blade. Because the overall mass of the wiper blade assembly 250 is fixed, predictable changes in the center of mass may be accounted for due to the predictable outputs of the input devices force sensors while the wiper blade assembly 250 is placed in each of its states or positions. This establishes a different baseline sensor reading for each dynamic component state. The appropriate baseline readings are subtracted from the sensor outputs depending on the known state of the dynamic component. This baseline may be in addition to any other estimated baseline that the input device employs. Advantageously, the wiper blade assembly 250 may act on one surface of the force-sensing element 205 without having any net effect on the ability of the force-sensing element 205 to measure and locate an external force applied to the force-sensing element 205.

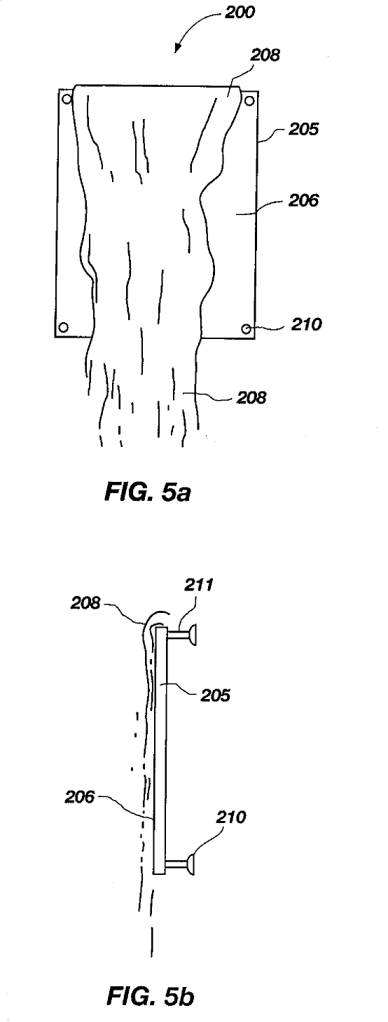

Referring now to FIGS. 5a and 5b, in an additional embodiment of the present invention, an input device comprising a fluid component passing over the surface of the input device is illustrated. Specifically, a force-based input device 200 is shown having a force-sensing element 205 and at least one force sensor 210. The force-based input device 200 is configured in a vertical orientation and water 208 is flowing downwards across a front surface 206 of the force-sensing element 205. In one aspect, the force sensors 210 are mounted at the base of legs 211 raising the force-sensing element 205 in a platform-type configuration. Advantageously, the dynamic movement of the water 208 across the surface of the force-sensing element 205 does not result in the registration of a force on the force-sensing element, as the force-sensing element 205 is configured in a vertical orientation and as forces applied by the water on the force-sensing element will be substantially parallel to the plane of the force-sensing element 205. While not shown, the force-sensing element 205 could equally be configured in a horizontal orientation. In this manner, water 208 could be moved across a front surface 208 of the force-sensing element 205. If the volume of water acting on the surface of the force-sensing panel remains constant, its static mass could be accounted for during calibration as described in more detail herein. Similarly, if its path across the surface of the force-sensing element is reasonably predictable (e.g., both temporally and spatially), any forces acting on the force-sensing element could also be accounted for during calibration.

In operation, each of the above-described functional attachments, and any others that might be used, operate as intended due to the underlying force-based technology in the force-based input device. Specifically, all of the applied forces, whether they are applied directly to the sensing surface of the force-sensing element, or to an input surface of a functional attachment, are transferred to the isolated beam segments of the force-based input device. This technology permits actual touch or input surfaces to be located in a different plane than the force-sensing element, whether above or below the force-sensing element. The signals generated by the applied forces within these planes are processed in a similar manner as those generated by application of forces directly on the sensing surface of the force-sensing element. Any changes in sensitivity resulting from application of force a distance away from the actual sensing surface of the force-sensing element may be accounted for in the signal processing and the software used to determine the location of the applied force.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A touch-based input device comprising:
a touch-sensing element configured to receive an applied force;
at least one sensor operable with a touch-sensing element to detect said applied force, said sensor being configured to generate a signal corresponding to the detection of said force; and
a dynamic component moveable about said touch-sensing element and operable to apply a dynamic force on said touch-sensing element.

2. The touch-based input device of claim 1, further comprising a dynamic component acting on said touch-sensing element, said dynamic component adapted to act on the touch-sensing element without registering a force on said touch-sensing element, and wherein said touch-sensing element is adapted to concurrently allow detection of an external stimulus acting on the touch-sensing element.

3. The touch-based input device of claim 2, wherein the dynamic component comprises a fluid moving across a surface of the touch-sensing element.

4. The touch-based input device of claim 3, wherein the external stimulus may be detected on a surface of the touch-sensing element that is covered with a fluid.

5. A touch-based input device comprising:
a touch-sensing element configured to receive an applied force;
at least one sensor operable with a touch-sensing element to detect said applied force, said sensor being configured to generate a signal corresponding to the detection of said force; and
a self-propelled dynamic component moveable about a surface of said touch-sensing element without registering a detectable force on said touch-sensing element,
wherein said touch-sensing element is adapted to allow concurrent detection of an external stimulus anywhere about the touch-sensing element.

6. The touch-based input device of claim 5, wherein the external stimulus may be detected in a boundary traced by said self-propelled dynamic component.

7. The touch-based input device of claim 5, wherein the dynamic component is mounted on a surface of the touch-sensing element.

8. The touch-based input device of claim 5, wherein the dynamic component is operable to transfer an external force applied to the dynamic component to the touch-sensing element.

9. The touch-based input device of claim 5, wherein the location of the center of mass of said dynamic component in the plane of the touch-sensing element is fixed.

10. The touch-based input device of claim 9, wherein the location of the center of mass of said dynamic component in the plane of the touch-sensing element remains fixed during movement of said dynamic component.

11. The touch-based input device of claim 5, wherein the dynamic component comprises a static mass, said static mass being accounted for during calibration of said touch-based input device.

12. The touch-based input device of claim 5, wherein said dynamic component comprises at least one moving element in contact with a surface of the touch-sensing element.

13. The touch-based input device of claim 12, wherein the velocity of the at least one moving element is variable.

14. The touch-based input device of claim 12, wherein the velocity of the at least one moving element is manually adjustable.

15. The force-based input device of claim 5, wherein said dynamic component operates to transfer an applied force to said touch-sensing element at a plurality of locations.

16. The touch-based input device of claim 5, wherein the maximum acceleration of any component of said dynamic component which applies force to the touch-sensing element is set at a predetermined level to prevent detection by said touch-sensing element.

17. The touch-based input device of claim 5, wherein the dynamic component is selected from the group consisting of an electric motor, a hydraulic motor, a pneumatic motor, an internal combustion motor, or any combination of these.

18. The touch-based input device of claim 5, wherein the dynamic component comprises a plurality of diametrically opposed arms connected to a common center axle.

19. The touch-based input device of claim 5, wherein the location of the center of mass of said dynamic component normal to the touch-sensing element is variable.

20. The touch-based input device of claim 5, wherein the location of the center of mass of said dynamic component in the plane of the touch-sensing element is variable.

21. The touch-based input device of claim 20, further comprising means for calibrating the touch-based input device to account for the variable center of mass.

22. A touch-based input device comprising:
a touch-sensing element configured to receive an applied force;
at least one sensor operable with a touch-sensing element to detect said applied force, said sensor being configured to generate a signal corresponding to the detection of said force; and
a dynamic component moveable about a surface of said touch-sensing element and operable to apply a dynamic force on said touch-sensing element,
wherein the sum of non-gravitational forces from the dynamic component acting on the touch-sensing element is substantially zero.

23. The touch-based input device of claim 22, wherein said dynamic component is configured to apply a first force to a front surface of the touch-sensing element and second force to a rear surface of the touch-sensing element, the magnitude of the first force being equal to the magnitude of the second force.

24. The touch-based input device of claim 22, wherein the dynamic component is configured to receive and transfer an external force to the touch-sensing element.

25. The touch-based input device of claim 23, wherein the first force and the second force are substantially parallel.

26. The touch-based input device of claim 23, wherein the first force and the second force are oriented in substantially opposite directions.

27. The touch-based input device of claim 23, wherein the touch-based input device is selected from the group consisting of resistive-based input devices, capacitance-based input devices, surface acoustic wave-based devices, force-based input devices, and infrared-based devices.

28. A force-based input device comprising:
a first structural element supported in a fixed position;
a second structural element operable with said first structural element, and dynamically supported to be movable with respect to said first structural element to define a force-sensing element configured to displace under an applied force;
a plurality of isolated beam segments joining said first and second structural elements, said isolated beam segments being operable to transfer forces between the first and second structural elements resulting from displacement of said force-sensing element;
at least one sensor operable to measure strain within each of said isolated beam segments resulting from said transfer of forces and said displacement of said force-sensing element; and
a dynamic component moveable about a surface of said touch-sensing element and operable to apply a dynamic force on said touch-sensing element.

29. A method of operating a touch-based input device, comprising:
obtaining a touch-sensing element, said touch-sensing element being operable to detect an applied force and facilitate determination of a location of said applied force with respect to the touch-sensing element;
operating a self-propelled dynamic component supported about a surface of said touch-sensing element, said dynamic component being moveable about said touch-sensing element and operable to apply a dynamic force on said touch-sensing element; and
applying an external force to the touch-sensing element to register a force and perform an intended function.

30. The method of claim 29, further comprising the step of operating the self-propelled dynamic component such that the center of mass of said self-propelled dynamic component is fixed.

31. A method of manufacturing a dynamic component operable with a touch-sensing element, comprising:
providing a touch-sensing element operable to detect an applied force and to facilitate determination of a location of said applied force with respect to the touch-sensing element; and
supporting a self-propelled dynamic component about said touch-sensing element, said dynamic component being moveable about said touch-sensing element and operable to apply a dynamic force on said touch-sensing element,
wherein said self-propelled dynamic component is supported, such that a sum of non-gravitational forces from said dynamic component acting on said touch-sensing element is substantially zero.
